(19) United States
(12) Patent Application Publication
(10) Pub. No.: US 2024/0017316 A1
(43) Pub. Date: Jan. 18, 2024

(54) METHOD AND SYSTEM FOR ELECTROSTATICALLY CHARGING STAMPING LUBRICANT TO CONTROL DEPOSITION

(71) Applicant: Ford Global Technologies, LLC, Dearborn, MI (US)

(72) Inventors: Yun Bai, Canton, MI (US); Andrey M. Ilinich, Novi, MI (US)

(73) Assignee: Ford Global Technologies, LLC, Dearborn, MI (US)

(21) Appl. No.: 18/360,255

(22) Filed: Jul. 27, 2023

Related U.S. Application Data
(63) Continuation-in-part of application No. 17/712,612, filed on Apr. 4, 2022.

(51) Int. Cl. B21D 37/18

(52) U.S. Cl. CPC B21D 37/18

(57) ABSTRACT

A method of lubricating a sheet of material includes moving the sheet along a first direction and operating a print nozzle to deposit a lubricant on the sheet while the sheet is moving along the first direction. The print nozzle ejects the lubricant in a second direction that is transverse to the first direction and toward a first side of the sheet. The method includes charging the lubricant so that the lubricant ejected from the print nozzle is in the form of charged droplets and applying an external electrical field between the print nozzle and the sheet to attract the charged droplets to the sheet.

### CROSS-REFERENCE TO RELATED APPLICATION

This application is a continuation-in-part of and claims the benefit of U.S. application Ser. No. 17/712,612, filed Apr. 4, 2022, and titled “METHOD AND SYSTEM FOR LUBRICATING AND FORMING A METAL COMPONENT FROM SHEET METAL”, the contents of which are incorporated herein by reference in its entirety.

### FIELD

The present disclosure relates to a method and system for lubricating and forming a metal component from sheet metal.

### BACKGROUND

The statements in this section merely provide background information related to the present disclosure and may not constitute prior art.

Some mass-produced metal components, such as body panels of a vehicle for example, can start as a coil of sheet metal. The coil is typically unrolled in a continuous manner while being cut into discrete, flat sheet metal blanks. The sheet metal blank is typically a discrete, flat sheet having a predetermined length and shape. Each sheet metal blank is then coated with a uniform thickness of a lubricant before being moved to a stamping press line or being stacked for storage until ready to be moved to the stamping press line. The stamping press line typically includes one or more stamping presses configured to form the flat sheet metal blank into a three-dimensional metal component. Some stamping presses also remove small amounts of sheet metal during the stamping process.

The lubricant is typically applied to the sheet metal blank in a uniform thickness across the entire length and width of the sheet metal blank without regard to the stamping process. Furthermore, the lubricant application systems currently used typically result in excess lubrication consumption as well as overspray, which requires complicated and expensive capture and recycling technologies. Additionally, stacking sheet metal blanks that are fully and uniformly lubricated can result in the lubrication squeezing out from the edges. This squeezed out lubrication can cause the stacked sheet metal blanks to stick together, which can make it difficult for an individual sheet metal blank to be removed from the stack, such as with a robotic arm for example. Unintentionally loading two sheet metal blanks stuck together into the stamping press can damage the stamping press and shut down production. Furthermore, excess lubrication can make it more difficult to clean, pretreat, and paint the metal components after stamping.

The present disclosure addresses these and other issues associated with traditional sheet metal lubrication and stamping operations and devices.

### SUMMARY

This section provides a general summary of the disclosure and is not a comprehensive disclosure of its full scope or all of its features.

According to one form in accordance with the teachings of the present disclosure, a method of lubricating a sheet of material includes moving the sheet along a first direction and operating a print nozzle to deposit a lubricant on the sheet while the sheet is moving along the first direction. The print nozzle ejects the lubricant in a second direction that is transverse to the first direction and toward a first side of the sheet. The method includes charging the lubricant so that the lubricant ejected from the print nozzle is in the form of charged droplets and applying an external electrical field between the print nozzle and the sheet to attract the charged droplets to the sheet.

According to variations of this method, which may be employed individually or in any combination: the method further includes adjusting a velocity of the charged droplets by adjusting the external electric field; a strength of the external electric field is controlled based on a speed of the sheet moving along the first direction; the sheet is a metal material; the lubricant is charged before being ejected from the print nozzle; the lubricant is charged as it is ejected or immediately after being ejected from the print nozzle; the print nozzle is located below the sheet; the external electric field is in the range of inventors to provide range in 30-120 kV/m; the charged droplets are charged with a positive charge; the positive charge is in the range of 10-200 kV; the charged droplets are charged to within the range of 10-200 kV; the lubricant is charged by a first charging device and the external electric field is provided by a second charging device separate from the first charging device.

According to another form in accordance with the teachings of the present disclosure, a method of lubricating a sheet of material includes moving the sheet along a first direction and operating a print nozzle to deposit a lubricant on the sheet while the sheet is moving along the first direction. The print nozzle ejects the lubricant in a second direction that is transverse to the first direction and toward a first side of the sheet. The method includes charging the lubricant with a first charging device so that the lubricant ejected from the print nozzle is in the form of charged droplets, operating a second charging device to apply an external electrical field between the print nozzle and the sheet to attract the charged droplets to the sheet, and adjusting a velocity of the charged droplets by adjusting a strength of the external electric field.

According to variations of this method, which may be employed individually or in any combination: the strength of the external electric field is controlled based on a speed of the sheet moving along the first direction; the print nozzle is located below the sheet.

According to still another form in accordance with the teachings of the present disclosure, a system for lubricating sheet metal to be formed into a metal component includes a print head, a first charging device, a second charging device, and a control module. The print head includes a plurality of nozzles. Each nozzle of the plurality of nozzles includes an aperture plate, an actuator, and a body. The aperture plate and the body cooperate to define a reservoir configured to hold lubricant. The actuator is configured to vibrate the lubricant in the reservoir to eject the lubricant as droplets through an aperture of the aperture plate. The first charging device is configured to electrically charge the lubricant. The second charging device is configured to produce an external electric field between the print head and the sheet metal. The control module is configured to control operation of the second charging device to selectively adjust a strength of the external electric field.

According to variations of this system, which may be employed individually or in any combination: the control module is configured to selectively adjust the strength of the external electric field based on a speed of the sheet moving along a first direction; the first charging device is configured to electrically charge the lubricant before the lubricant is ejected from the print nozzle; the first charging device is configured to electrically charge the lubricant as it is ejected or immediately after being ejected from the print nozzle; the first charging device is configured to electrically charge the lubricant in the range of 10-200 kV and the external electric field is in the range of 30-120 kV/m.

According to one form in accordance with the teachings of the present disclosure, a method of manufacturing a metal component is provided. The method includes performing a test stamping process on a test sheet metal blank, generating a strain map of the test sheet metal blank for the test stamping process, generating a lubrication program based on the strain map, applying lubrication to the sheet metal according to the lubrication program, and stamping the sheet metal to form the metal component. The lubrication program is configured to control a lubrication system to apply lubrication to sheet metal in a non-uniform distribution across the sheet metal. The non-uniform distribution correlates to the strain map.

According to variations of this method, which may be employed individually or in any combination: the lubrication is applied by a print head including a plurality of print nozzles, each print nozzle being individually controlled by the lubrication program; the method further includes moving the sheet metal linearly while the print head applies the lubrication to the sheet metal; the lubrication program is configured to apply the lubrication according to a first thickness to a first region of the sheet metal and to apply the lubrication according to a second thickness to a second region of the sheet metal, the first thickness being thicker than the second thickness; the first region of the sheet metal correlates to a region of the strain map that has higher strain than a region of the strain map that correlates to the second region of the sheet metal; the print head is configured to apply pixels of lubrication to the sheet metal such that a size of each pixel of lubrication is 20 micrometers to 3,000 micrometers; the lubrication program is configured to: change spacing between the pixels, or change the size of the pixels, or change both the spacing between the pixels and the size of the pixels; the plurality of print nozzles includes a first subset of print nozzles and a second subset of print nozzles, wherein applying lubrication to the sheet metal includes applying a liquid lubricant to the sheet metal from the first subset of print nozzles and applying a dry-film lubricant to the sheet metal from the second subset of print nozzles; the lubrication program is configured to apply less lubrication proximate to edges of a sheet metal blank; applying the lubrication to the sheet metal according to the lubrication program includes applying a dry-film lubricant in a machine readable pattern; the method further includes scanning the metal component for defects and automatically adjusting the lubrication program based on defects detected; the test sheet metal blank is a computer model of a physical sheet metal blank and the test stamping process is a computer simulation of a stamping process, wherein the computer simulation generates the strain map; the test sheet metal blank is a physical piece of sheet metal and the test stamping process physically deforms the test sheet metal blank, wherein the method includes inspecting the test sheet metal blank after the test stamping process and the strain map is generated based on the inspection of the test sheet metal blank after the test stamping process; the method further includes operating a blanking machine on the sheet metal, the blanking machine removing material from a discrete length of the sheet metal to form a sheet metal blank; the lubrication is applied to the sheet metal according to the lubrication program before the blanking machine removes the material from the discrete length of the sheet metal to form the sheet metal blank; the lubrication is applied to the sheet metal according to the lubrication program after the blanking machine removes the material from the discrete length of the sheet metal to form the sheet metal blank.

According to another form in accordance with the teachings of the present disclosure, a method of manufacturing a metal component includes: performing a computer simulation of a stamping process to be performed on a sheet metal blank, the computer simulation calculating a strain map of the sheet metal blank for the stamping process; generating a lubrication program based on the strain map, the lubrication program being configured to control a print head to apply lubrication to sheet metal material so that the lubrication has a thickness that varies across the sheet metal material, the thickness being correlated to the strain map; applying lubrication to the sheet metal material according to the lubrication program; cutting the sheet metal material into a predetermined shape to define the sheet metal blank; and stamping the sheet metal blank to form the metal component.

According to variations of this method, which may be employed individually or in any combination: the lubrication program is configured to control the print head to apply a first thickness of lubrication to a first region of the sheet metal material and to apply a second thickness of lubrication to a second region of the sheet metal material, the first thickness being thicker than the second thickness, wherein the first region of the sheet metal material correlates to a region of the strain map that has higher strain than a region of the strain map that correlates to the second region of the sheet metal material; the print head includes a plurality of print nozzles, each print nozzle being individually controlled by the lubrication program, wherein the method includes moving the sheet metal material past the print head while the print head remains stationary and applies the lubrication to the sheet metal material according to the lubrication program.

According to another form in accordance with the teachings of the present disclosure, a system for lubricating sheet metal to be formed into a metal component is provided. The system includes a print head and at least one control module. The print head includes a plurality of lubricant nozzles. Each lubricant nozzle of the plurality of lubricant nozzles is individually controllable to selectively eject lubricant onto the sheet metal according to a lubrication program. The at least one control module is configured to generate the lubrication program based on a strain map. The strain map is an output of a computer simulation of a stamping process to be performed on the sheet metal. The at least one control module is configured to control operation of the print head to apply the lubricant to the sheet metal according to the lubrication program.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic flow chart of a method of producing a metal component from sheet metal in accordance with the teachings of the present disclosure;

FIG. 2 is a schematic perspective view of a lubrication device in accordance with the teachings of the present disclosure;

FIG. 3 is a schematic bottom view of a portion of a print head of the lubrication device of FIG. 2 in accordance with the teachings of the present disclosure;

FIG. 4 is a schematic cross-sectional view of one example of a nozzle for use in the print head of FIG. 3;

FIG. 5 is a schematic top view of an example of a pixel lubrication spray pattern from the print head of FIG. 3 in accordance with the teachings of the present disclosure;

FIG. 6 is a top view of an example of a bar code lubrication spray pattern from the print head of FIG. 3 in accordance with the teachings of the present disclosure;

FIG. 7 is a top view of a second example of a bar code lubrication spray pattern from the print head of FIG. 3 in accordance with the teachings of the present disclosure;

FIG. 8 is top view of a strain map of a metal component in accordance with the teachings of the present disclosure;

FIG. 9 is a schematic bottom view of a portion of a lubrication system of another configuration in accordance with the teachings of the present disclosure;

FIG. 10 is a schematic bottom view of a portion of a lubrication system of yet another configuration in accordance with the teachings of the present disclosure;

FIG. 11 is a schematic side view of a lubrication system of yet another configuration in accordance with the teachings of the present disclosure;

FIG. 12 is a schematic side view of a lubrication system of still another configuration in accordance with the teachings of the present disclosure;

FIG. 13 is a schematic top view of a lubrication system of yet another configuration in accordance with the teachings of the present disclosure;

FIG. 14 is a schematic top view of a lubrication system of another configuration in accordance with the teachings of the present disclosure; and

FIG. 15 is a schematic side view of a lubrication system of still another configuration in accordance with the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

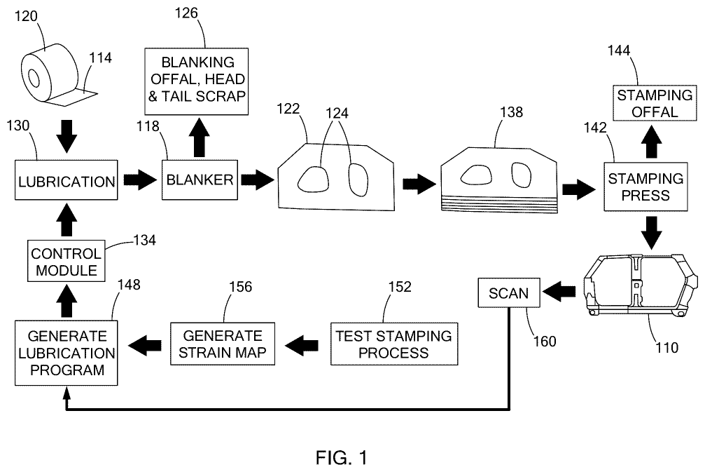

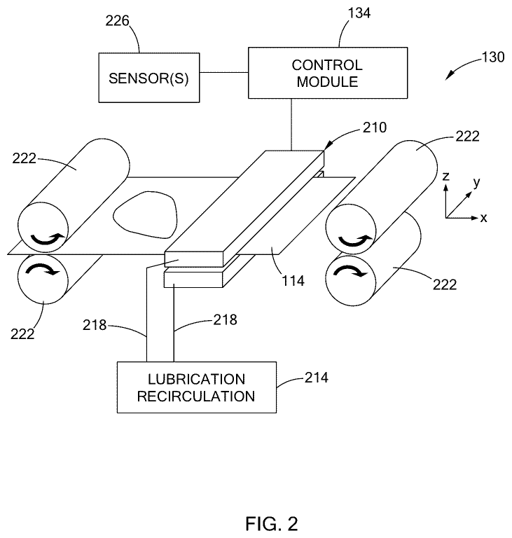

Referring to FIG. 1, a flow chart of a method and system of manufacturing a metal component 110 is illustrated. Sheet metal material 114 is fed through a lubrication system 130, such as by rollers (not specifically shown but may be similar to those shown in FIG. 2 for example).

In one form, the sheet metal material 114 can be unrolled from a coil 120 of metal. In one form, the sheet metal material 114 may be cut into predetermined discrete lengths from the coil 120 before being fed through the lubrication system 130 such that discrete, rectangular, flat sheets of metal are fed into the lubrication system 130. In another form, the lubrication system 130 acts on the continuous sheet of metal from the coil 120.

At the lubrication system 130, lubrication is applied to the sheet metal material 114. The application of the lubrication is controlled by a control module 134, as described in greater detail below. While described herein as “a” control module 134, it is to be understood that one or more control modules may be used.

After lubrication, the sheet metal material is fed into a blanker 118 or blanking machine, such as by rollers (not specifically shown but may be similar to those shown in FIG. 2 for example). The blanker 118 performs blanking operations to form a sheet metal blank 122. The sheet metal blank 122 is a predefined overall shape and can optionally include cut-outs 124. The blanking operation produces offal or scrap 126, such as metal material removed to define the shape and any cut-outs 124. The blanking operation can also sever the metal material from the coil 120 such that the sheet metal blank 122 is a discrete piece of metal material if not already severed before or after lubrication.

In the example provided, the sheet metal blank 122 is a flat sheet having a predefined shape. In an alternative configuration, not specifically shown, the sheet metal blank 122 may include minor or initial bends. In the specific example provided, the metal component 110 is a vehicle body or frame panel and the cut-outs 124 are rough openings that correspond to door and/or window openings in the final metal component 110, though other types of metal components can be manufactured.

While illustrated and described herein as lubricating the sheet metal material 114 before the blanking process of the blanker 118, in an alternative configuration, not specifically illustrated, the lubrication system 130 can be after the blanker 118 such that the lubrication is applied in a similar manner as that discussed below but to the sheet metal blank 122 after being processed by the blanker 118. In yet another configuration, not specifically illustrated, the lubrication system similar to lubrication system 130 can be included before and after the blanker 118 such that the lubrication applied before the blanker 118 can be specific to the blanking operation and the lubrication applied after the blanker 118 can be specific to the subsequent stamping operations.

With additional reference to FIG. 2, the lubrication system 130 includes the control module 134 and a print head 210. The print head 210 is in communication with the control module 134 and the control module 134 is configured to control operation of the print head 210, as described in detail below. The lubrication system 130 may also optionally include a lubrication capture and recirculation system 214 configured to catch and reuse or recycle excess lubrication. The lubrication capture and recirculation system 214 can be any suitable system and may include such devices as pumps (not specifically illustrated), recirculation conduits 218 and filters (not specifically illustrated) for example.

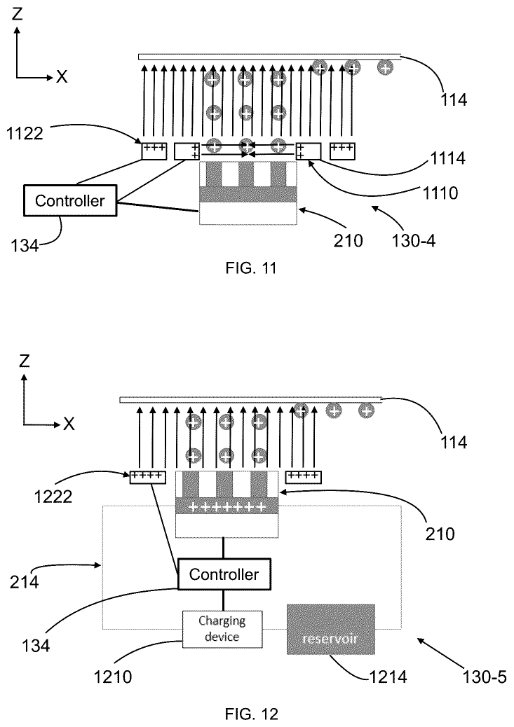

In the example provided, the print head 210 is stationary and the sheet metal material 114 is translated past the print head 210 while the print head 210 ejects lubrication onto the sheet metal material 114 as the sheet metal material 114 is moving past. For example, the sheet metal material 114 may be translated by rollers 222, though other configurations can be used. In the example provided, the print head 210 is located above the path of the sheet metal material 114 such that the print head 210 sprays lubricant on a top surface of the sheet metal material 114. In an alternative configuration, such as those shown in FIGS. 11 and 12 for example, the print head 210 can be positioned below the path of the sheet metal material 114 to spray lubricant on the bottom surface of the sheet metal material 114 or, while not specifically shown, more than one print head may be used such that one sprays the top surface and another sprays the bottom surface.

One or more sensors 226 can be in communication with the control module 134 and configured to detect the sheet metal material 114, such as detecting its position in the X and/or Y direction relative to the print head 210 for example. The sensors 226 may also be configured to detect the width of the sheet metal material 114.

While the sheet metal material 114 is illustrated as translating horizontally, other orientations can be used. While pairs of rollers 222 are illustrated such that the sheet metal material 114 passes between two rollers 222 of each pair, other configurations can be used, e.g., rollers 222 only being located below the sheet metal material 114.

Returning to FIG. 1, after lubrication 130 and blanking 118, the lubricated sheet metal blank 122 may optionally be stacked with other lubricated sheet metal blanks to form a stack 138 of sheet metal blanks. The sheet metal blank 122 is then removed from the stack 138 and moved to a stamping press 142. In an alternative configuration, the sheet metal blank 122 can proceed directly to the stamping press 142 without being stacked.

In yet another alternative configuration, not specifically illustrated, the lubrication system 130 can be located after the stack 138 of sheet metal blanks and before the stamping press 142.

The stamping press 142 performs stamping operations on the sheet metal blank 122. These stamping operations can press the sheet metal blank 122 between dies (not specifically shown) that can shape the sheet metal blank 122 into three-dimensional shapes. The stamping operations may optionally remove additional offal or scrap 144. While one stamping press 142 is schematically illustrated, a plurality of stamping presses can be used to achieve the final three-dimensional shape of the metal component 110.

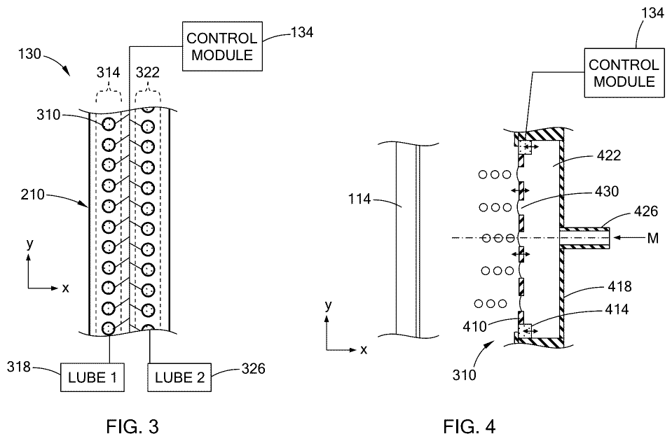

Referring to FIG. 3, the print head 210 includes a plurality of nozzles 310. Each nozzle 310 is connected to the control module 134 for electrical communication therewith and is configured to be controlled independently of each other nozzle 310. As such, each nozzle 310 is individually addressable such that the control module 134 is configured to independently activate and deactivate each nozzle 310 according to a lubrication program, described in greater detail below.

The print head 210 includes a first set of nozzles (i.e., the nozzles 310 within dashed line region 314) connected to a lubrication source 318, which may include at least a reservoir (not specifically shown) and a pump (not specifically shown) for example. In the example provided, the first set of nozzles 314 may be arranged in an array along the Y-direction while the sheet metal material 114 (FIG. 2) is configured to translate in the X-direction relative to the print head 210, though other arrangements may be used. The print head 210 may optionally include a second set of nozzles 322 that can be arranged in a second array along the Y-direction, though other arrangements can be used. The print head 210 can be configured to span the entire width (i.e., in the Y-direction) of the sheet metal material 114 (FIG. 2).

In the example provided, the second set of nozzles 322 may be connected to a second lubrication source 326 that may optionally be separate from the first lubrication source 318. The first lubrication source 318 and the second lubrication source 326 can optionally supply different types of lubrication. In one form, the first lubrication source 318 provides a liquid lubricant and the second lubrication source 326 provides a solid lubricant such as a powder or dry-film wax for example. In an alternative configuration, not specifically shown, both the first set of nozzles 314 and the second set of nozzles 322 can be connected to the same lubrication source. While two arrays of nozzles 310 are illustrated, the nozzles 310 can be arranged in other configurations.

The nozzles 310 can be any suitable type of nozzle configured to be independently controlled and to print the lubrication with precision providing pixels of lubrication between 20 micrometers and 3,000 micrometers in size.

With reference to FIG. 4, one example of a nozzle 310 is schematically illustrated. The example nozzle 310 of FIG. 4 is a piezoelectrically actuated nozzle, though other types of nozzles can be used. In some forms, this type of nozzle may be referred to as an ultrasonic atomizer. The example nozzle 310 includes an aperture plate 410, an actuator 414, and body 418. The body 418 and the aperture plate 410 cooperate to define a reservoir 422 configured to hold a volume of lubricant. The body 418 defines an inlet 426 open to the reservoir 422 and configured to supply lubricant material M to the reservoir 422. The aperture plate 410 defines one or more apertures 430. In the example provided, a plurality of apertures 430 are illustrated, but in an alternative form, a single aperture or more or fewer apertures than shown can be used. The actuator 414 is a piezoelectric actuator configured to vibrate the aperture plate 410. Vibration of the aperture plate 410 causes the lubricant to be ejected from the nozzle 310 through the apertures 430.

In some alternative forms, the actuator 414 may be attached to the body 418 separate from the aperture plate 410, such as within the reservoir 422 for example, and configured to produce acoustic pressure waves in the lubricant that is within the reservoir 422. The acoustic pressure waves can cause the lubricant to be ejected from the nozzle 310 through the apertures 430.

In still other forms, the nozzles 310 can be other types of printing nozzles known in the art. For example, the nozzles 310 can be piezoelectric jetting nozzles, thermal jetting nozzles, valve jetting nozzles or other ink jet nozzles that are capable of printing pixels of between 20 micrometers and 3,000 micrometers in size.

Returning to FIG. 1, the control module 134 is configured to control the operation of each nozzle 310 (FIG. 3) independently based on a lubrication program 148. In order to generate the lubrication program 148, a test stamping process 152 is performed on a test sheet metal blank. Based on the results of the test stamping process 152, a strain map 810 (FIG. 8) is generated at step 156. The lubrication program 148 is generated based on the strain map 810 (FIG. 8).

In one form, the test stamping process 152 is a simulated stamping process performed on a computer (not specifically shown) such that the test sheet metal blank is a computer model of the actual sheet metal blank 122. The test sheet metal blank is loaded in a computer program that performs a simulation (e.g., finite element analysis) of the stamping process on the test sheet metal blank (i.e., the computer model). The computer program generates a strain map from the simulation performed on the test sheet metal blank. The strain map 810 (FIG. 8) can include values indicative of strain at different locations along the test sheet metal blank. The strain map 810 may optionally also include other values such as coefficient of friction values, thickness values, locations of potential cracking, among other values.

A computer (e.g., the same computer or a different computer than the one that generated the strain map 810) can then generate the lubrication program based on the strain map 810. For example, the lubrication program can be configured to provide higher thicknesses of lubrication to locations where the strain map 810 indicates high levels of strain. Additionally, or alternatively, the lubrication program can be configured to provide higher levels of lubrication where the resulting material is thinner and/or where the simulation predicts cracking may occur.

In one form, the lubrication program can reduce or eliminate lubrication from being applied within a predetermined distance from the edges of the sheet metal blank 122 such that a border 814 (FIG. 8) of lower or no lubrication will result.

In an alternative form, the test sheet metal blank can be a physical sheet metal blank (similar to sheet metal blank 122) and the test stamping process 152 can include physically stamping the test sheet metal blank. The stamped test sheet metal blank can then be measured or scanned to generate the strain map 810. For example, the stamped test sheet metal blank can be physically measured with tools or scanned with three-dimensional scanners (not shown) such as laser scanners, radar scanners, optical scanners, or other suitable scanners. The measurements can indicate strain at different locations along the test sheet metal blank. For example, the measurements can measure changes in thickness, and/or locations where cracking occurred. The measured values, correlated to their locations on the test sheet metal blank, result in the strain map 810. The strain map 810 is then used to generate the lubrication program 148 in a manner similar to that described above with reference to the computer simulated test stamping process 152.

In one form, the test stamping process can optionally include test runs (e.g., actual physical tests or computer simulated test runs) of both the stamping process and the blanking process such that the strain map 810 is based on the operations of both the blanker 118 and the stamping press 142 and the lubrication program is based on both operations.

The control module 134 uses the lubrication program to control selective activation of the nozzles 310 to apply the lubrication to the actual sheet metal material 114 such that the lubrication is applied non-uniformly across the sheet metal material 114, in a manner that correlates to the strain map 810.

The metal component 110, after one or more stamping operations, can optionally be scanned 160 (e.g., optical scanners, laser scanners, etc.) and any defects can be used to modify the lubrication program to generate a new lubrication program 148 for the control module 134. In one form, the result of the scan 160 may be utilized by machine learning to automatically adjust the lubrication program.

Referring to FIG. 8, an example strain map 810 is illustrated for the sheet metal blank 122 of the example provided. In FIG. 8, the strain map 810 and sheet metal blank 122 is illustrated superimposed over a discrete length of the sheet metal material 114 for ease of understanding. In FIG. 8, different regions or levels of strain are indicated by different shading or colors. While FIG. 8 shows a visual representation of a strain map, the strain map may be merely a set of data correlating to the strain values and their corresponding locations (e.g., coordinates) on the sheet metal blank 122. It is understood that different applications will have sheet metal blanks of different sizes, shapes, and contours and that the strain map for different applications will be different.

In one form, the lubrication program can be configured to apply lubrication according to a first thickness to a first region 818 of the sheet metal material 114 and to apply the lubrication according to a second thickness to a second region 822 of the sheet metal material 114, the first thickness being thicker than the second thickness. In one form, the first region 818 of the sheet metal material 114 correlates to a region of the strain map 810 that has higher strain than a region of the strain map 810 that correlates to the second region 822 of the sheet metal material 114. Any number of regions having different strain levels, and consequently, different lubrication thicknesses or types can be used based on the resolution of the simulation or measurements and the resolution of the print head 210.

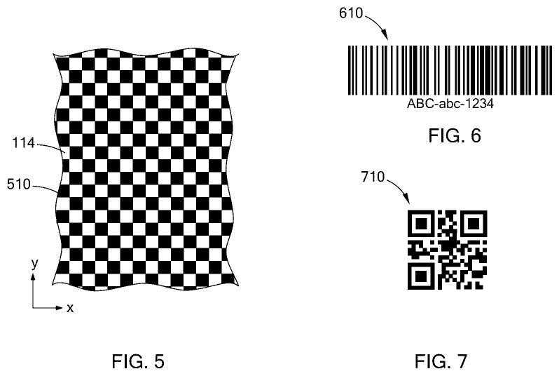

Referring to FIG. 5, another feature of the lubrication system 130 (FIGS. 1 and 2) is that the control module can control precise application of the lubricant to produce pixels 510 of lubrication. In the example shown in FIG. 5, the lubrication is illustrated as the shaded squares and areas without lubrication are illustrated as blank squares. While square pixels are illustrated, other shapes can be used depending on the construction of the nozzles 310 (FIGS. 3 and 4), such as rounded pixels for example. As discussed above, the pixels are in the range of 20 micrometers to 3,000 micrometers in size.

In one form, illustrated in FIG. 5, the pixels can alternate between lubricated pixels 510 and non-lubricated pixels over a given area of the sheet metal material 114. In some applications, such a distribution of lubrication can provide adequate lubrication coverage while using less lubrication than uniformly coating the entire region.

In another form, the lubrication program can be configured to change the spacing between the pixels 510 and/or change the size of the pixels 510 (i.e., still within the range of 20 micrometers to 3,000 micrometers) across the sheet metal material 114 based on the strain map 810.

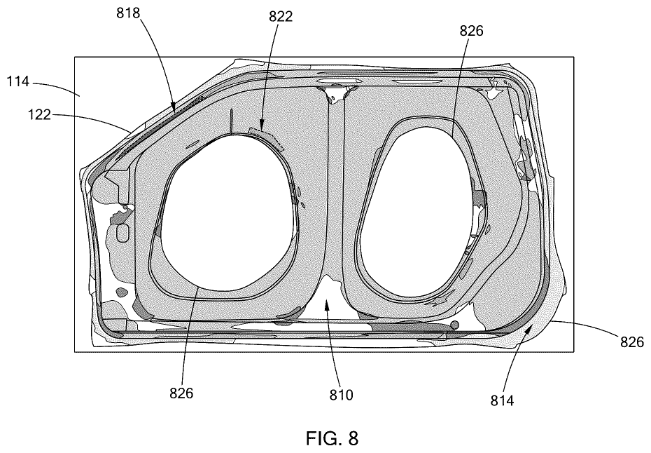

In another form, illustrated in FIGS. 6 and 7, the precise pixelated control of the lubrication application can permit the lubrication to be applied to certain locations of the sheet metal material 114 in the form of a barcode 610 (FIG. 6) or 710 (FIG. 7). FIGS. 6 and 7 illustrate a linear barcode and a 2-D barcode (e.g., QR code), respectively, but other types of barcodes or scannable codes can be used. In one form, the lubrication can optionally be a material that fluoresces under a particular wavelength range (e.g., ultra-violet) and a scanner (not shown) utilizing that wavelength range can be used to scan the sheet metal material 114 (e.g., before or after stamping).

The barcode 610 or 710 can include any suitable information. In one form, the barcode 610 or 710 may include lot number and/or dates of the metal and/or of the lubrication, though other information can be used. For example, the information may be indicative of a vehicle part number and/or location of manufacture, among other information. While machine scannable barcodes are shown, other information may be printed in addition to or instead of a barcode, such as text or symbols readable by a person for example.

In the examples provided, the barcode 610 and 710 is applied with a dry-film lubricant, though other configurations can be used.

In another form, referring again to FIG. 8, the lubrication program can be configured to provide the border 814 of less lubrication (or no lubrication) within a predefined distance from edges 826 (e.g., the perimeter and/or edges defining cutouts) of the sheet metal blank 122. By providing less lubrication proximate the edges, stacked sheet metal blanks 122 can be easier to separate.

Additionally, the precise print head 210 and individual control of the nozzles 310 of the print head 210 permit different sizes and shapes of sheet metal material or blanks to be used with the same lubrication system 130 by merely changing the lubrication program.

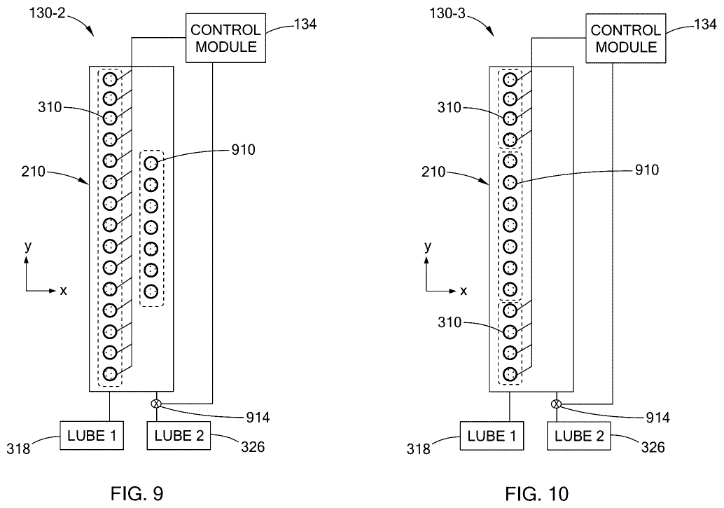

Referring to FIG. 9, a lubrication system 130-2 of a second construction is illustrated. The lubrication system 130-2 is similar to the lubrication system 130 (FIGS. 1-3) except as otherwise shown or described herein. Accordingly, similar features are indicated with similar numbers and only differences will be explained in detail. Specifically, the lubrication system 130-2 includes a plurality of nozzles 310 that are individually controllable and an array of nozzles 910 that are not individually controllable, but instead are all controlled together.

In the example provided, the nozzles 910 are arranged generally in the center of the path that the sheet metal material 114 will pass, though other configurations can be used. The nozzles 910 all provide lubrication at the same time in a uniform amount. The control module 134 can be in communication with a valve 914 between the lubricant supply 326 and the nozzles 910. When the valve 914 is open, the lubricant flows from all of the nozzles 910.

In the example provided, the lubricant supply 326 is separate from the lubricant supply 318, though other configurations can be used. In one form, the lubricant supplies 318, 326 provide the same type of lubricant. In an alternative form, the lubricant supplies 318, 326 provide different types of lubricant. In an alternative configuration some of the nozzles 910 may have more apertures or different sized apertures such that different amounts of lubricant can exit from each nozzle 910 despite all of the nozzles operating at the same time based on the condition of the valve 914.

The nozzles 910 can optionally be electrostatically charged to charge the lubrication leaving the nozzles 910 so as to be attracted to the sheet metal material 114. In one configuration, the individually controllable nozzles 310 are not electrostatically charged. In another configuration, the individually controllable nozzles 310 may be electrostatically charged.

In the example provided, the individually controllable nozzles 310 are arranged in an array (similar to FIG. 3) across the entire width of the path of the sheet metal material 114. In an alternative configuration, shown in FIG. 10 and designated by reference numeral 130-3, the individually controllable nozzles 310 can be located only across the path of the sheet metal material 114 where the nozzles 910 are not configured to spray. For example, the nozzles 910 may be located to spray generally in the middle of the path while the nozzles 310 are only located proximate the edges of the path.

As a result, different numbers of the nozzles 310 can selectively be turned on or off to avoid overspray when the lubrication system 130-2 or 130-3 is used for different width sheet metal components. Thus, the lubrication system 130-2 or 130-3 may optionally provide lubrication for different widths of sheet metal and may provide the lubrication as a uniform or non-uniform distribution. Alternatively, the lubrication system 130-2 or 130-3 can provide reduced lubrication near the edges while providing either a uniform or non-uniform distribution across the middle. In the case of lubrication system 130-3, non-uniform distribution across the middle can be achieved with predetermined different numbers or sizes of apertures among the nozzles 910.

Referring to FIG. 11, a portion of a lubrication system 130-4 is illustrated. The lubrication system 130-4 is similar to the other lubrication systems of the present disclosure except as otherwise shown or described herein. Accordingly, similar features are indicated with similar numbers and only differences will be explained in detail. Specifically, the lubrication system 130-4 is configured to spray upwards from below the sheet metal material 114 and the lubrication system 130-4 includes a charging device 1110 in communication with the control module 134. In other words, the positive Z direction shown is up and gravity acts in the opposite (negative Z) direction. In an alternative form, not specifically shown, gravity may act in the positive or negative X direction or at an angle relative to the X and Z directions. In the example provided, the sheet metal material 114 is moving in the positive X direction relative to the print head 210.

While not shown, an additional print head (e.g., upper print head) may optionally be disposed above the sheet metal material 114 to spray the top surface thereof.

The charging device 1110 is configured to electrically charge the lubrication particles as they traverse the air gap between the print head 210 and the sheet metal material 114. In the form in which the optional upper print head is included, the upper print head may optionally have a corresponding charging device (not shown) or not.

In the example provided, the charging device 1110 includes one or more plates 1114 that create an electric field (schematically illustrated by the opposing arrows between the plates 114) that is configured to charge the particles and is controlled by the control module 134. The plates 1114 can be coupled to the print head 210 or can be separate therefrom and disposed between the print head 210 and the sheet metal material 114. In the example provided, the charging device 1110 applies a positive charge to the particles. In another form, the charging device applies a negative charge to the particles. In one form, the charging device 1110 can charge the lubrication particles to a charge in the range of 10-200 kV.

Referring to FIG. 12, a portion of a lubrication system 130-5 is illustrated. The lubrication system 130-5 is similar to the other lubrication systems of the present disclosure except as otherwise shown or described herein. Accordingly, similar features are indicated with similar numbers and only differences will be explained in detail. Specifically, the lubrication system 130-5 is configured to spray upwards from below the sheet metal material 114 and the lubrication system 130-5 includes a charging device 1210 in communication with the control module 134. In other words, the positive Z direction shown is up and gravity acts in the opposite (negative Z) direction. In an alternative form, not specifically shown, gravity may act in the positive or negative X direction or at an angle relative to the X and Z directions. In the example provided, the sheet metal material 114 is moving in the positive X direction relative to the print head 210.

While not shown, an additional print head (i.e., upper print head) may optionally be disposed above the sheet metal material 114 to spray the top surface thereof.

The charging device 1210 is configured to electrically charge the lubrication before it leaves the print head 210. In one form, the charging device 1210 is between a lubrication reservoir 1214 and the print head 210, such as within the lubrication recirculation system 214 for example. In another form, not specifically shown, the charging device 1210 is attached to or within the print head 210. In one form, the charging device 1210 can charge the lubrication particles in the range of 10-200 kV. In the form in which the optional upper print head is included, the upper print head may optionally receive charged lubrication from the same charging device 1210 as the print head 210 or the upper print head may have a corresponding charging device (not shown) or may be configured to not spray charged lubricant.

Referring to both FIGS. 11 and 12, the lubrication system 130-4 or 130-5 can be configured such that sheet metal material 114 may optionally be grounded or oppositely charged to attract the charged lubrication droplets. Alternatively, the sheet metal material 114 may optionally be positioned between the external charging device 1122 and a grounded or oppositely charged electrode.

The control module 134 can be configured to control and selectively vary an external electric field (schematically illustrated by the arrows pointing in the positive Z direction) applied between the print head 210 and the sheet metal material 114. In one form, this electric field is applied in the range of 0-120 kV/m, and in some forms more specifically between 30-120 kV/m.

In one form, the voltage applied by the charging device 1110 or 1210 (e.g., when the charging device 1110 1210 is mounted to or proximate the print head 210) can be varied to selectively vary the electric field between the print head 210 and the sheet metal material 114. For example, the charging device 1110 can create the electric field between the print head 210 and the sheet metal material 114 or if the charging device 1210 is mounted to the print head 210, it can charge the print head 210 to create the electric field between the print head 210 and the sheet metal material 114.

In another form, the control module 134 can control application of an external electric field via an optional external charging device 1122 or 1222. The external charging device 1122 or 1222 may be in addition to the charging device 1110 or 1210 and is not specifically configured to charge the particles of lubrication. For example, in one form, the charging device 1122 or 1222 may be further from the apertures 430 (labeled in FIG. 4) than the charging device 1110 or 1210. Instead, the external charging device 1122 or 1222 merely creates an external electrical field in the gap between the print head 210 and the sheet metal material 114 through which the already charged particles traverse.

The control module 134 can selectively vary the external electrical field to selectively vary the speed at which the charged lubricant particles fly toward the sheet metal material 114. As such, the velocity of the lubricant particles can be controlled and varied without the need to change the waveform or voltage of the actuators 414 (FIG. 4), which would also change the ejected particle size. In one form, the control module 134 can adjust the electric field based on a speed of the sheet metal material 114 and/or a distance between the print head 210 and the sheet metal material 114. For example, a stronger electric field may be used for faster speeds of the sheet metal material 114 and/or for greater distances.

While shown with the print head 210 ejecting the droplets perpendicularly to the movement of the sheet metal material 114, other configurations can be used, such as at a non-perpendicular angle, for example.

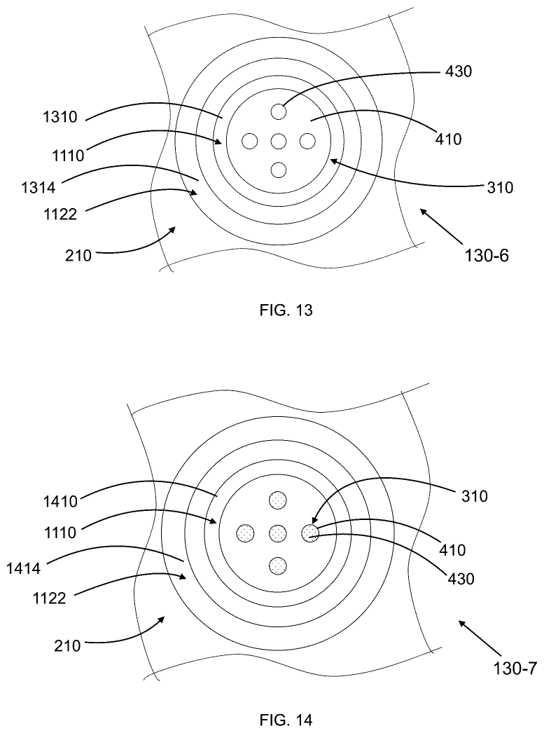

Referring to FIG. 13, a schematic top view of one alternative form of a lubrication system 130-6 is illustrated. The lubrication system 130-6 is similar to the other lubrication systems of the present disclosure except as otherwise shown or described herein. Accordingly, similar features are indicated with similar numbers and only differences will be explained in detail. In this example, the one or more plates 1114 (FIG. 11) is a ring 1310 and the external charging device 1122 is also in the form of a ring 1314. In this example, the ring 1310 surrounds a single one of the nozzles 310. In this example, the ring 1314 also surrounds a single one of the nozzles radially outward of the ring 1310, though other configurations can be used.

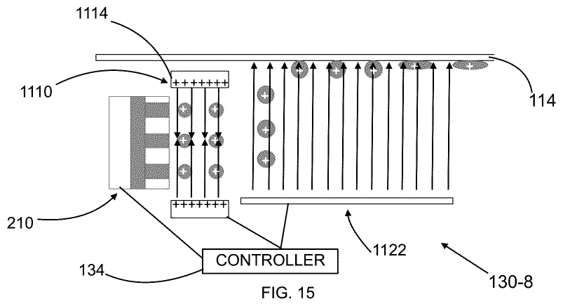

Referring to FIG. 14, a schematic top view of one alternative form of a lubrication system 130-7 is illustrated. The lubrication system 130-7 is similar to the other lubrication systems of the present disclosure except as otherwise shown or described herein. Accordingly, similar features are indicated with similar numbers and only differences will be explained in detail. In this example, the one or more charging plates 1114 is a ring 1410 and the external charging device 1122 is also in the form of a ring 1414. In this example, the ring 1410 surrounds a plurality of the nozzles 310. In this example, the ring 1414 also surrounds a plurality of the nozzles radially outward of the ring 1410, though other configurations can be used.

Referring to FIG. 15, one non-limiting example of a lubrication system 130-8 in which the print head ejects the droplets in a direction non-perpendicular to the movement of the sheet metal material 114 is illustrated. In this example, the droplets are ejected in the same direction as the movement of the sheet metal material 114, though other configurations can be used. The lubrication system 130-8 is similar to the other lubrication systems of the present disclosure except as otherwise shown or described herein. Accordingly, similar features are indicated with similar numbers and only differences will be explained in detail. In the example provided, the electric field produced by the external charging device 1122 changes the direction of the charged ejected droplets. The controller 134 can control the strength of the electric field produced by the external charging device 1122 to control the speed at which the droplets are redirected toward the sheet metal material 114. While the droplets are shown as being charged by external plates 1114, the material may alternatively be charged in the manner shown and described with reference to FIG. 12.

Referring to FIGS. 11-15, when print heads 210 are positioned on both sides (e.g., above and below) the sheet metal material 114, the droplets on one side of the sheet metal material 114 may be charged with an opposite polarity than the droplets on the opposite side. In this way, the electric field generated by the external charging device 1122 drives the droplets from both print heads 210 toward the sheet metal material 114.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” and/or “control module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method of lubricating a sheet of material, the method comprising:
moving the sheet along a first direction;
operating a print nozzle to deposit a lubricant on the sheet while the sheet is moving along the first direction, wherein the print nozzle ejects the lubricant in a second direction that is transverse to the first direction and toward a first side of the sheet;
charging the lubricant so that the lubricant ejected from the print nozzle is in the form of charged droplets; and
applying an external electrical field between the print nozzle and the sheet to attract the charged droplets to the sheet.

2. The method according to claim 1, further comprising adjusting a velocity of the charged droplets by adjusting the external electric field.

3. The method according to claim 1, wherein a strength of the external electric field is controlled based on a speed of the sheet moving along the first direction.

4. The method according to claim 1, wherein the sheet is a metal material.

5. The method according to claim 1, wherein the lubricant is charged before being ejected from the print nozzle.

6. The method according to claim 1, wherein the lubricant is charged as it is ejected or immediately after being ejected from the print nozzle.

7. The method according to claim 1, wherein the print nozzle is located below the sheet.

8. The method according to claim 1, wherein the external electric field is in the range of 30-120 kV/m.

9. The method according to claim 1, wherein the charged droplets are charged with a positive charge.

10. The method according to claim 9, wherein the positive charge is in the range of 10-200 kV.

11. The method according to claim 1, wherein the charged droplets are charged to within the range of 10-200 kV.

12. The method according to claim 1, wherein the lubricant is charged by a first charging device and the external electric field is provided by a second charging device separate from the first charging device.

13. A method of lubricating a sheet of material, the method comprising:
moving the sheet along a first direction;
operating a print nozzle to deposit a lubricant on the sheet while the sheet is moving along the first direction, wherein the print nozzle ejects the lubricant in a second direction that is transverse to the first direction and toward a first side of the sheet;
charging the lubricant with a first charging device so that the lubricant ejected from the print nozzle is in the form of charged droplets;
operating a second charging device to apply an external electrical field between the print nozzle and the sheet to attract the charged droplets to the sheet; and
adjusting a velocity of the charged droplets by adjusting a strength of the external electric field.

14. The method according to claim 13, wherein the strength of the external electric field is controlled based on a speed of the sheet moving along the first direction.

15. The method according to claim 13, wherein the print nozzle is located below the sheet.

16. A system for lubricating sheet metal to be formed into a metal component, the system comprising:
a print head, including a plurality of nozzles, each nozzle of the plurality of nozzles including an aperture plate, an actuator, and a body, the aperture plate and the body cooperating to define a reservoir configured to hold lubricant, the actuator configured to vibrate the lubricant in the reservoir to eject the lubricant as droplets through an aperture of the aperture plate;
a first charging device configured to electrically charge the lubricant;
a second charging device configured to produce an external electric field between the print head and the sheet metal; and
a control module configured to control operation of the second charging device to selectively adjust a strength of the external electric field.

17. The system according to claim 16, wherein the control module is configured to selectively adjust the strength of the external electric field based on a speed of the sheet moving along a first direction.

18. The system according to claim 16, wherein the first charging device is configured to electrically charge the lubricant before the lubricant is ejected from each nozzle.

19. The system according to claim 16, wherein the first charging device is configured to electrically charge the lubricant as it is ejected or immediately after being ejected from each nozzle.

20. The system according to claim 16, wherein the first charging device is configured to electrically charge the lubricant in the range of 10-200 kV and the external electric field is in the range of 30-120 kV/m.
